(19) United States
(12) Patent Application Publication
(10) Pub. No.: US 2014/0253033 A1
(43) Pub. Date: Sep. 11, 2014

(54) SYSTEM AND METHOD FOR AUTOMATICALLY CHARGING A BATTERY DURING MOTION

(71) Applicant: WORKING POWER SOLUTIONS, LLC, Marietta, GA (US)

(72) Inventors: CHARLES STANCIL, MARIETTA, GA (US); WILLIAM SCALIA, DAWSONVILLE, GA (US)

(21) Appl. No.: 13/784,864

(22) Filed: Mar. 5, 2013

(51) Int. Cl. B60L 11/18

(52) U.S. Cl. CPC B60L 11/1809
USPC 320/109

(57) ABSTRACT

A system and method for controlling the operation of an electrically operated vehicle. The system comprises a digital commutation system for charging electric vehicle batteries. That system includes an electromagnet, an electromagnet status sensor, and a controller. The electromagnet is coupled to a crankshaft and configured both to receive a current from the batteries and to supply charge to them The electromagnet status sensor is configured to detect a status of the electromagnet and the controller is configured to control coupling of the electromagnet to batteries based on the detected electromagnet status as well as to monitor the current received by and the charge supplied from the electromagnet. The method includes supplying a current to the electromagnet, producing a electromagnetic field in the electromagnet winding, pulling the electromagnet core into the winding, and then collapsing the electromagnetic field, capturing and storing the charge corresponding to the collapsed field.

### TECHNICAL FIELD

Embodiments of the present disclosure are generally related to battery electric vehicles (BEV) and more particularly to charging systems for BEVs.

### BACKGROUND

Electric automobiles, such as battery electric vehicles (BEVs), are gaining widespread popularity because of increased oil prices and concerns regarding the reduction of greenhouse gases. Typically, a BEV includes an onboard battery connected to an electric motor. The battery provides necessary voltage to the electric motor and the electric motor, in turn, converts the electric energy stored in the battery into mechanical energy for moving the vehicle. Generally, once the electric charge in the battery is depleted, the on-board batteries are recharged using specialized wired or wireless charging stations.

Even though BEVs greatly reduce greenhouse gases and utilize a cleaner energy source than conventional vehicles do, most people are hesitant to buy electric vehicles. The main reason for this hesitation lies in the BEV battery pack. Unlike conventional vehicles, which require a maximum of a five minute stop for refueling, electric vehicles may require anywhere between 3-12 hours for a complete battery recharge. Moreover, charging stations are not as readily available as refueling stations. In addition to these problems, another major issue with electric vehicles is the distance they can travel before they require recharging. Even on a complete charge, most electric vehicles can only travel about 60 miles before they require recharging.

Many automobile manufacturers are attempting to overcome these battery-related problems. For instance, some manufacturers have developed superior battery technology that may allow vehicles to travel up to 120 miles per charge. These batteries, however, are very expensive. Other manufacturers have invented technologies to recharge the battery with the energy dissipated from braking, termed regenerative braking. The regenerative braking method of recharging, however, is typically effective in cases where the vehicle brakes frequently, as, in city peak-hour traffic, but it has proved ineffective in suburban or rural areas. Accordingly, even given the advancest in battery technology and the use of regenerative braking to recharge batteries automatically, there exists a need for battery charging systems that can reduce the charging frequency and increase the distance traveled per charge.

### SUMMARY

An aspect of the present disclosure is a digital commutation system for charging one or more batteries of an electric vehicle. That system includes an electromagnet, electromagnet status sensor, and a controller. The electromagnet is coupled to a crankshaft of the electric vehicle and configured to be operatively coupled to the one or more batteries to receive a current from the one or more batteries and supply charge to the one or more batteries. The electromagnet status sensor configured to detect a status of the electromagnet. The controller is configured to control coupling of the electromagnet to the one or more batteries based on the detected electromagnet status as well as to monitor the current received by the electromagnet and the charge supplied from the electromagnet.

Another aspect of the disclosure is a process for charging a battery of an electric vehicle. That process includes supplying a current to an electromagnet, the electromagnet comprising an electromagnetic winding and a core present within the winding, where the core is coupled to a crankshaft of the vehicle and where supply of the current is controlled by a controller. The process also includes producing an electromagnetic field, in the electromagnetic winding, based on the supplied current, and then forcing pulling the core into the electromagnet based on the produced electromagnetic field. Then the process collapses the electromagnetic field by ceasing supply of the current to the electromagnet via the controller, storing a charge corresponding to the collapsed electromagnetic field.

Yet another aspect of the disclosure is a vehicle operating under electric power, the vehicle comprising a digital commutation system for charging one or more batteries of an electric vehicle. That system includes an electromagnet, electromagnet status sensor, and a controller. The electromagnet is coupled to a crankshaft of the electric vehicle and configured to be operatively coupled to the one or more batteries to receive a current from the one or more batteries and supply charge to the one or more batteries. The electromagnet status sensor configured to detect a status of the electromagnet. The controller is configured to control coupling of the electromagnet to the one or more batteries based on the detected electromagnet status as well as to monitor the current received by the electromagnet and the charge supplied from the electromagnet.

### BRIEF DESCRIPTION OF THE FIGURES

FIG. 1 is a block diagram illustrating an exemplary electric vehicle according to embodiments of the present disclosure.

FIG. 2 is a block diagram illustrating an exemplary charging system according to embodiments of the present disclosure.

FIG. 3 illustrates an exemplary process for charging batteries of the electric vehicle according to embodiments of the present disclosure.

FIG. 4 illustrates an exemplary process for charging batteries of the electric vehicle according to another embodiment of the present disclosure.

FIG. 5 is a block diagram illustrating another exemplary charging system according to embodiments of the present disclosure.

FIG. 6 is a block diagram illustrating yet another exemplary charging system according to embodiments of the present disclosure.

FIG. 7 illustrates a typical crankshaft.

FIG. 8 illustrates an exemplary axle of the electric vehicle with the exemplary charging system of FIG. 6.

While the invention is amenable to various modifications and alternative forms, specific embodiments are shown by way of example in the drawings and are described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims.

### DETAILED DESCRIPTION

Embodiments of the present disclosure are related to battery electric vehicles (BEVs) and systems and methods for charging batteries of electric vehicles. More particularly, the methods and systems are configured to recharge the battery of the electric vehicle while the vehicle is in motion. To this end, instead of using an electric motor to power the vehicle, embodiments of the present disclosure utilize an electromagnet-plunger assembly to power the vehicle. Moreover, the battery of the vehicle may be recharged from the same electromagnet-plunger assembly.

It will be noted that even though embodiments of the present disclosure are described with respect to electric vehicles, the application of the systems described herein is not restricted to electric vehicles. Instead, these charging systems may be utilized in numerous other applications as well. For instance, the charging systems may be employed in hybrid vehicles, in a power plant, in agricultural equipment, and in mining equipment without departing from the scope of the present disclosure.

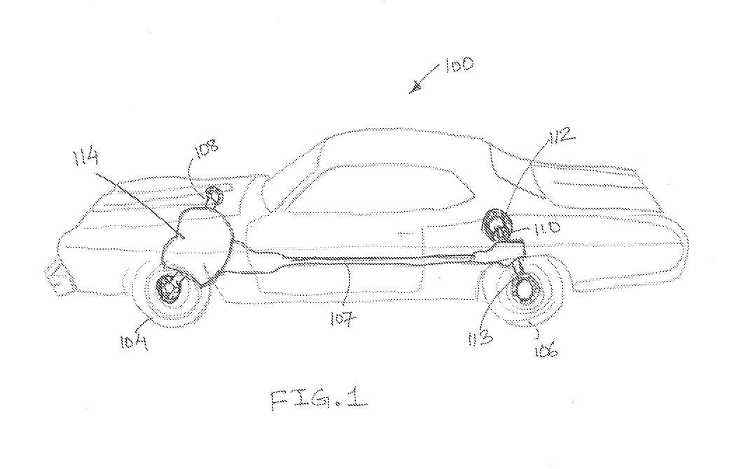

FIG. 1 illustrates an exemplary electric vehicle 100 according to embodiments of the present disclosure. The electric vehicle may be an automobile, an all-terrain vehicle, a sport utility vehicle, a watercraft, or any other suitable vehicle, all within the scope of the present disclosure. In the presently contemplated embodiment, the vehicle 100 is an automobile.

Accordingly, the vehicle 100 includes four wheels with two front wheels 104 and two rear wheels 106. The front wheels 104 are connected through a front axle 108 and similarly, the two rear wheels 106 are connected through a rear axle 110. The front wheels 104 and the rear wheels 106 may be connected through a drive shaft 107. Further, one or more crankshafts 112 and a flywheel 113 may be coupled to the axles 108, 110. It will be noted that in a two-wheel drive type vehicle, either the front wheels 104 or the rear wheels 106 are the drive wheels, while the other wheels follow the motion of the drive wheels. In these vehicles, the crankshafts 112 and flywheel 113 may be coupled to the axles of the drive wheels. Alternatively, in an all-wheel drive type vehicle, the front and rear wheels 104, 106 are the drive wheels. In these vehicles, the crankshafts 112 and flywheel 113 may be coupled to both the front and rear axles. Rotation of the crankshafts 112 rotates the flywheel 113 and the wheels 104, 106 of the vehicle 100.

Further, the crankshafts 112 may be coupled to a digital commutation system 114, which provides the necessary mechanical energy to rotate the crankshafts 112 and the wheels 104, 106. Further, the vehicle 100 may include one or more batteries 116. In some embodiments, the digital commutation system 114 may be configured to recharge the batteries 116 of the electric vehicle while the vehicle 100 is in motion, thereby allowing the vehicle 100 to travel larger distances per stationary charge. As used herein, the term stationary charge refers to the charge supplied to one or more batteries at a charging station while the vehicle 100 is stationary.

It will be understood that the vehicle 100 may include any other typical electrical vehicle parts such as a transmission, drive train, suspensions, seats, electrical systems, or power controllers without departing from the scope of the present disclosure.

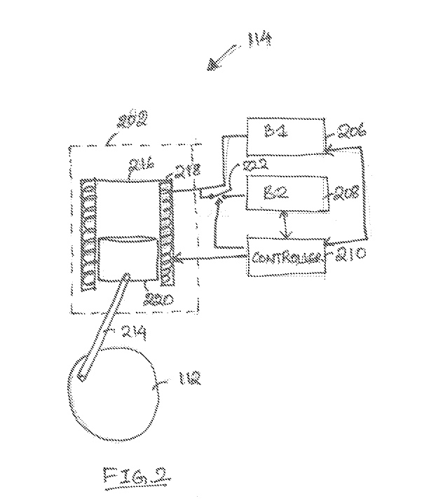

FIG. 2 is a block diagram 200 illustrating the digital commutation system 114 according to some embodiments of the present disclosure. Here, digital commutation system 114 includes an electromagnet 202, coupled to the one or more batteries 116. In FIG. 2, the batteries 116 are illustrated as two separate entities—a first battery 206 and a second battery 208. In other embodiments, however, the batteries 116 may be implemented as a single battery with two or more sections, as a serial arrangement of multiple batteries, or as a parallel arrangement of multiple batteries. In addition to the electromagnet 202, the digital commutation system 114 includes a controller 210 coupled to the batteries 116 and the electromagnet 202. Further, as illustrated, the electromagnet 202 may be mechanically coupled to the crankshaft 112 through a connecting rod 214. It is recognized that the “first” and “second” designations of the batteries 116 are for identification purposes only, and do not suggest a particular order of implementation.

In some embodiments, the electromagnet 202 may include a casing or shell 216 within which an electromagnetic winding 218 is disposed. A core 220, such as a cylindrical plunger, may be slidably disposed within the casing 216 and the core may be pivotally connected to the connecting rod 214. The electromagnetic winding 218 may be a solenoid, which is essentially a helical coil wrapped around a metallic core. When an electric current is passed through the electromagnetic winding 218, an electromagnetic field may be produced around the electromagnetic winding 218.

Based on the mechanical arrangement of the electromagnet 202, it will be noted that when the electromagnetic winding 218 produces an electromagnetic field, the core 220 may be pulled upward into the shell 216 of the electromagnet 202 or downwards out of the shell 216. Conversely, when the electromagnet 202 is de-energized, the core 220 may return to its original position. It will be understood that when current is supplied to the electromagnetic winding 218, the winding 218 behaves as a magnet with north and south poles. Depending on the polarity of the poles, the core 220 may be pulled upwards or downwards when the winding 218 is energized. However, in this disclosure, to maintain uniformity, it is assumed that when the electromagnetic winding 218 is energized, the core 220 is pulled upwards into the shell 216 and when the electromagnetic winding 218 is de-energized, the core 220 returns to its original position.

As described previously, the one or more batteries 116 are connected to the electromagnet 202. In one embodiment, the batteries 116 may be connected such that at a given time, one battery is directly connected to the electromagnet 202, while the other batteries are disconnected. To this end, the digital commutation system 114 employs one or more switches 222 in the connection between the batteries 116 and the electromagnet 202. For instance, as depicted in FIG. 2, the first battery 206 is directly connected to the electromagnet 202, while a second battery 208 is connected through the switch 222. When the switch 222 is open, the first battery 206 may be connected to the electromagnet 202. Moreover, when the switch 222 is closed, the first battery 206 is disconnected and the second battery 208 is connected to the electromagnet 202. Similarly, it may be understood that as the number of batteries 116 increases, more switches 222 may be employed in the connections between the electromagnet 202 and the batteries 116. Further, the switches 222 may be electromechanical, electrical, or electronic switches. For example, the switches 222 may be relays or diodes.

Any known secondary battery chemistries may be employed in the batteries 116 without departing from the scope of the present disclosure. For instance, the batteries 116 may include nickel-cadmium batteries, Nickel-Zinc batteries, Nickel-metal hydride batteries, lead-acid batteries, silver-zinc batteries, or lithium-ion batteries. Moreover, if more than one battery is utilized, the batteries 116 may have the same chemistry or different chemistries without departing from the scope of the present disclosure. For instance, the first battery 206 may be of the lead-acid type while the second battery 208 may be of the lithium-ion type.

As illustrated in FIG. 2, the switches 222, the batteries 116, and the electromagnet 202 may also be coupled to the controller 210. The controller 210 may be a microcontroller, a microprocessor, or any other computing device capable of managing the operation of the digital commutation system 114. For instance, the controller 210 may be configured to detect the electric charge supplied to the electromagnet 202, the charge supplied from the electromagnet 202, the remaining charge in the batteries 116 and so on. Moreover, the controller 210 may be configured to operate the switches 222 and control the timing for delivering charge to the electromagnet 202.

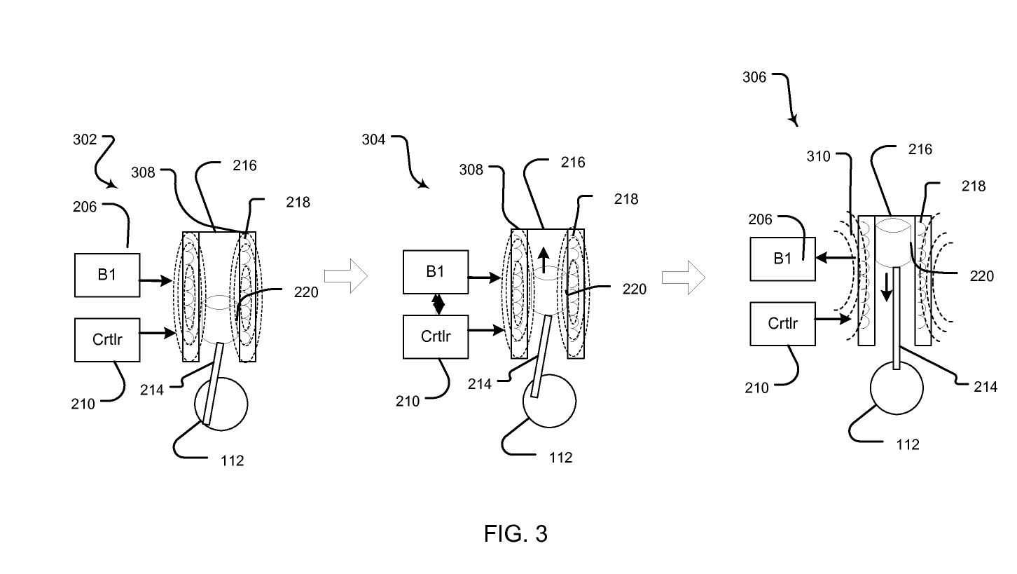

To monitor the batteries 116 the digital commutation system 114 may include one or more sensors (not shown) operatively coupled to the batteries 116 or present in the electrical pathways between the electromagnet 202 and the batteries 116. Further, to control operation of the switches 222 and the batteries 116, the controller 210 may also include software and/or control logic. Functionality of the controller 210 will be described in detail with reference to FIG. 3.

FIG. 3 illustrates an exemplary self-charging process 300, according to embodiments of the present disclosure. More particularly, the process 300 may be represented by three stages. In the first stage 302, the electromagnet 202 is energized; in the second stage 304, an electromagnetic field is produced; and in third stage 306, the electromagnet 202 is de-energized. FIG. 3 will be described with reference to FIGS. 1-2.

In the first stage 302, the electromagnetic winding 218 receives an electric current from the first battery 206. Moreover, at this stage, the switch 222 is open and the controller 210 senses the current transmitted from the first battery 206 to the electromagnet 202. It will be noted that as the switch 222 is open, the second battery 208 is disconnected from the electromagnet 202. Further, as current passes through the electromagnetic winding 218, an electromagnetic field is produced around and within the electromagnet 202. The electromagnetic field may be radially uniform within and outside the electromagnet 202. This field is generally represented by reference numeral 308.

In the second stage 304, the electromagnetic winding 218 continues to receive current from the first battery 206 and the electromagnetic field 308 is produced in the electromagnet 202. Further, as the first battery 206 is still supplying current to the electromagnet 202 in this stage, the first battery 206 is connected to the electromagnet 202 and the second battery 208 is disconnected.

Because of the electromagnetic field 308 created within the shell 216, the core 220 may be pulled into the shell 216 at this stage. Moreover, as the core 220 moves upwards, a tension may be placed on the connecting rod 214, which in turn may cause the crankshaft 112 to rotate in a clockwise direction. The degree of rotation of the crankshaft 112 may depend on the length of the electromagnetic winding 218, the current flowing through the electromagnetic winding 218, the strength of the current, the length of the connecting rod 214, and the size of the core 220, among other factors. Typically, the controller 210 may connect the first battery 206 to the electromagnet 202 until the core 220 reaches a position that causes the portion of the connecting rod 214 coupled to the crankshaft to reach a top center position with respect to the crankshaft 112. If the core 220 were pulled any higher than this position, the crankshaft may not be able to move. Typically, from the first stage 302 to the end of the second stage 304, the crankshaft 112 may rotate at least by about 45°. Thereafter, the digital commutation system 114 enters the third stage 306.

At the beginning of the third stage 306, the core 220 may be positioned towards the top of the shell 216 due to the electromagnetic forces produced by the electromagnetic winding 218. At this moment, the controller 210 may be programmed to stop the supply of electric current from the first batter 206 to the electromagnet 202. Specifically, the controller 210 may disconnect the first battery 206 from the electromagnet 202 and connect the second battery 208 to the electromagnet 202 by closing the switch 222. Consequently, the electromagnetic field 308 in the electromagnet 202 may begin to collapse. Reference numeral 310 generally represents the collapsing electromagnetic field.

According to embodiments of the present disclosure, the collapsed electromagnetic field 310 may be converted back into an electric charge, and this electric charge may be supplied from the electromagnet 202 to the second battery 208 through the electrical pathway between the electromagnet 202 and the second battery 208. This charge may be stored in the second battery 208 based on a pulse width modulation (PWM) technique. Further, as the electromagnetic field 308 collapses, the core 220 may return to its original position, thereby pushing the connecting rod 214 downwards and further rotating the crankshaft 112 in a clockwise direction. The three stages may repeat continuously to move the vehicle forward. Accordingly, the controller 210 may connect and disconnect the first and second batteries to the electromagnet 202 such that the electromagnet 202 receives current from the first battery 206 in pulses and provides charge to the second battery 208 in pulses.

As described previously, in one embodiment, the current may be stored in the battery 208 based on a PWM technique. To this end, the controller 210 may include a PWM program and the digital commutation system 114 may include a PWM charging system between the electromagnet 202 and the second battery 208. The software and hardware may govern the amount and timing of the charge entering the battery 208.

It will be noted that the controller 210 may be configured to control the timing of the three stages and the operation of the switch 222. More particularly, the controller 210 may be configured to precisely control the timing of current applied to the electromagnet 202. For instance, the controller 210 may monitor the status of the electromagnet 202 during operation. Accordingly, the digital commutation system 114 may include an electromagnet status sensor 224. The status sensor 224 may detect the position of the core 220 with respect to the shell 116 or the angle of the connecting rod 214 with respect to the core 220. Based on the detected status of the electromagnet, the controller 210 may be configured to switch the connection of the batteries 116 to the electromagnet 202. For instance, in case the status detector is a core position monitor, the controller 210 may be configured to disconnect the first battery 206 and connect the second battery 208 to the electromagnet 202 when the core 220 reaches a predetermined threshold position. Any known status sensor may be utilized to determine the position of the core 220 or the angle of the crankshaft 214. For instance, a crankshaft encoder may be utilized. Alternatively, an optical sensor, or a displacement sensor may be utilized. It will be understood that any other known sensor technology may be utilized to determine the status of the electromagnet 202 without departing from the scope of the present disclosure.

Further, depending on the number of electromagnets in the digital commutation system 114 and the acceleration demanded by the driver, the controller 210 may be configured to switch the batteries 206 and 208 very quickly; for example, in microseconds. With such quick switching, the digital commutation system 114 may achieve very rapid rise and collapse of the electromagnetic field. For such quick switching, the controller 210, batteries 116, and the switches 222 may include fast transistors, such as MOSFETs.

Further, as described previously, the controller 210 may be configured to sense the current supplied to the electromagnet 202 and the current received from the electromagnet 202 through current sensors (not shown) disposed in the pathways between the first and second batteries 206, 208 and the electromagnet 202. Moreover, the controller 210 may be configured to continuously monitor the current received from each cycle of the digital commutation system 114 to determine the total charge accumulated in the second battery 208. Further, the controller 210 may be configured to compare the accumulated current in the second battery 208 with a predetermined threshold value. If the accumulated current exceeds the threshold value, the controller 210 may be configured to either permanently disconnect the second battery 208 from the electromagnet 202 or disconnect the second battery 208 intermittently so that the second battery 208 may be charged at a slow rate. In one embodiment, the threshold value may be about 80% of a fully charged battery.

In case the controller 210 stops charging the second battery 210 once the threshold value is achieved, the second battery 208 may be disconnected from the electromagnet 202. Subsequently, the controller 210 may connect any other battery that is low on charge to the electromagnet 202 for charging. Alternatively, if all batteries are charged up to their threshold levels, the controller 210 may be configured to disconnect all batteries in the third stage of the self-charging process.

In one embodiment, the controller 210 may be configured to switch roles of the first and second batteries 206, 208 once the second battery 208 is charged to the threshold value. Accordingly, the second battery 208 may be connected to the electromagnet 202 in the first and second stages of the self-charging process, while the first battery 206 may be connected to the electromagnet 202 in the third stage. This way, the first battery 206 may be charged from the electromagnet 202, while the second battery 208 may supply the electric current to the electromagnet 202.

FIGS. 2-3 illustrate the crankshaft 112 coupled to one electromagnet 202. In this configuration, the first stage may begin when the portion of the connecting rod 214 connected to the crankshaft 112 is positioned at a bottom center position with respect to the crankshaft 112. Moreover, by the end of the second stage, the core 220 may travel a distance that causes the portion of the connecting rod 214 coupled to the crankshaft 112 to reach a top center position with respect to the crankshaft 112. Subsequently, when the core 220 returns to its original position, the portion of the connecting rod coupled to the crankshaft 112 may return to the bottom center position and the cycle may repeat again. Such cyclic motion of the core 220 and crankshaft 112 leads to a continuous rotation of the crankshaft 112. Accordingly, the motion of the core 220 from the first stage to the end of the third stage creates a torque that may turn the drive wheels of the vehicle 100 and set the vehicle 100 in motion.

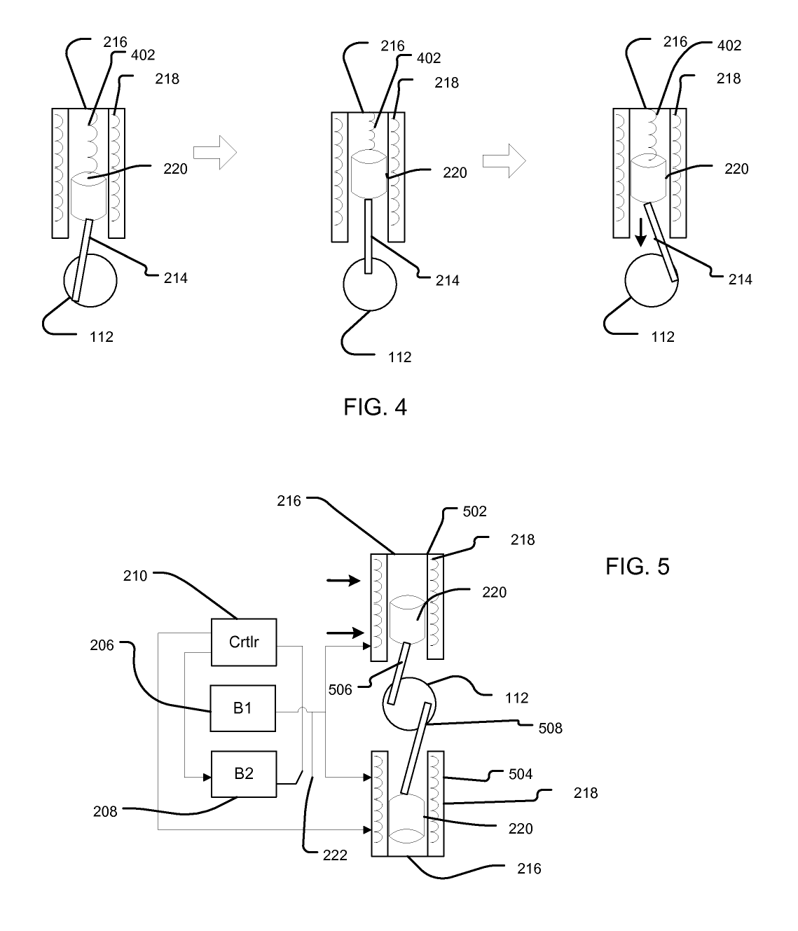

In some embodiments, the electromagnet 202 may not have enough potential and/or kinetic energy to return to its original position once the electromagnetic field 308 has collapsed. In such cases, the digital commutation system 114 may incorporate a spring assembly mechanically coupled to the shell 216 and the core 220. Specifically, the spring assembly may couple the core 220 to the top center of the shell 216. FIG. 4 illustrate a process 400 of the digital commutation system 114 with a spring assembly 401. In the first stage 402, the spring 401 remains extended and the core 220 is positioned towards the bottom of the shell 216. However, in the second stage 404, when the core 220 is pulled upwards because of the electromagnetic field 308, the spring 401 may be compressed and in turn may store potential energy. Subsequently, in the third stage 406, when the electromagnetic field collapses, the spring 401 may provide additional energy to the core 220 to return to its original position and rotate the crankshaft 112 by a further 180 degrees.

Alternatively, instead of a single electromagnet 202, the digital commutation system 114 may employ two electromagnets that are positioned 180° apart from each other along the crankshaft 112. FIG. 5 illustrates this embodiment. Here, a first electromagnet 502 is coupled with the connecting rod 504 to the crankshaft 112. Moreover, a second electromagnet 506 is coupled with a second connecting rod 508 to another portion of the crankshaft 112. In this case, the first electromagnet 502 may rotate the crankshaft 112 from 270° to 90°, while the second electromagnet 506 may rotate the crankshaft from 90° to 270°. The operation of the electromagnets remains the same.

The first electromagnet 502 may complete stages 1-3 and then the second electromagnet 506 may complete stages 1-3. With this arrangement, the controller 210 may control the timing of the first and second electromagnets' stages such that the first stage of the second electromagnet begins immediately after the end of the first electromagnet's third stage.

Further, it will be noted that the first and second electromagnets 502, 504 may both be connected to the same first battery 206 for their first and second stages and to the same second battery 208 for their third stages. However, it may just as easily be contemplated to connect the first electromagnet 502 to the first battery 206 for its first two stages, while the second electromagnet 506 may be coupled to the second battery 208 for its first two stages. Alternatively, in case more batteries are present, the first electromagnet 502 may be coupled to a first and second battery during its first two stages and third stage, respectively; while, the second electromagnet 506 may be coupled to a third and fourth battery during its first two stages and third stage, respectively.

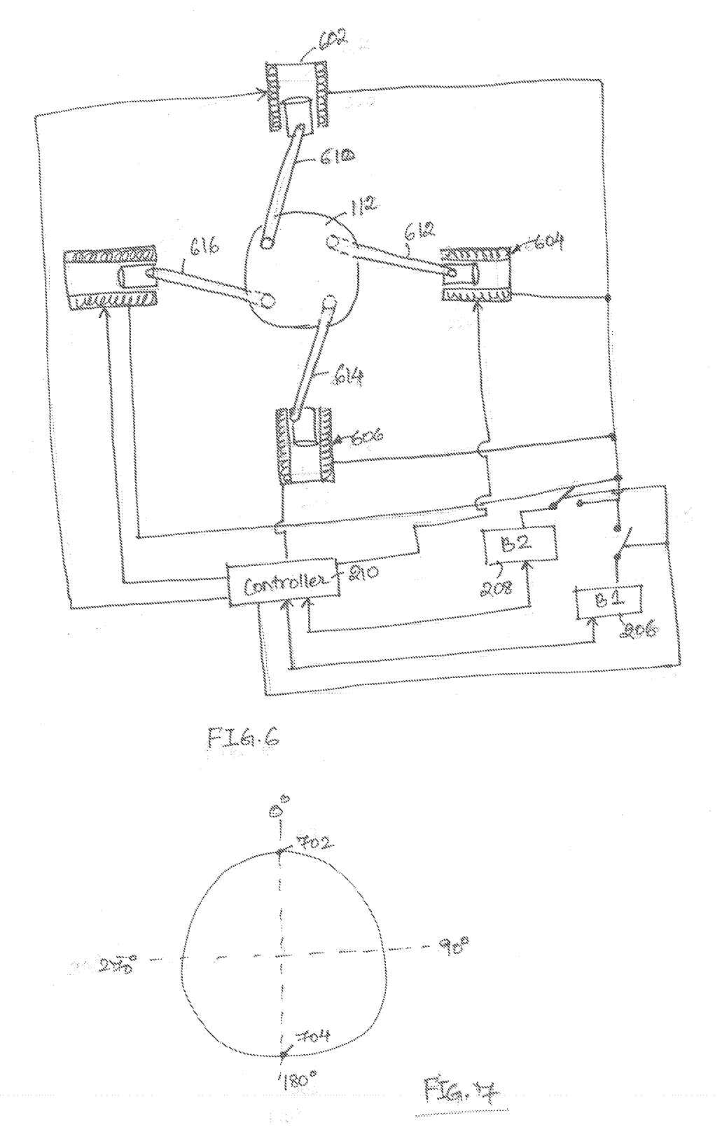

Similarly, the digital commutation system 114 may include four electromagnets separated from each other by about 90°. FIG. 6 illustrates this embodiment. Here, the digital commutation system 114 includes four electromagnets 602, 604, 606, and 608. Further, the four electromagnets are coupled to the crankshaft 112 by means of four connecting rods 610, 612, 614 and 616. Each electromagnet, in turn, may be coupled to two batteries. In one embodiment, all the electromagnets may be coupled to first and second batteries 206, 208. Alternatively, the electromagnets may be coupled to different batteries without departing from the scope of the present disclosure. In the presently contemplated embodiment of FIG. 6, the same first and second batteries are coupled to the four electromagnets. Again, this is merely exemplary and other configurations as possible. Furthermore, the controller 210 may be coupled to each of the electromagnets, to the batteries, and to the switches associated with the batteries. Operation of this assembly will be described in the following sections.

FIG. 7 illustrates the crankshaft 112 in terms of degrees. 0° is assumed to be the top center 702 of the crankshaft 112. Accordingly, the bottom center 704 is 180°. Half points between the top center 702 and the bottom center 704 mark the 90° and 270° marks. According to this figure, in the starting position, the first connecting rod 610 makes an angle of about 315° with the crankshaft 112, the second connecting rod 612 makes an angle of 45° with the crankshaft 112, the third connecting rod 614 makes an angle of about 135° with the crankshaft 112 and the fourth connecting rod 616 makes an angle of about 225° with the crankshaft 112.

To being this process, the first battery 206 may be coupled to the first electromagnet 602 and a current may be supplied from the first battery 206 to the first electromagnet 602. Such current may energize the first electromagnet 602 and induce the second stage of the process in which the core 220 is pulled upwards into the shell. As the core 220 is pulled upwards, tension is applied to the connecting rod 610, which in turn rotates the crankshaft 112 in a clockwise direction. When the status sensor 224 detects that the connecting rod 610 is at 0°, the controller 210 may disconnect the first battery 206 from the first electromagnet 602 and connect the second battery 208 instead. Accordingly, the electromagnetic field collapses, a charge corresponding to this field is stored in the second battery 208, and the core 220 returns to its original position, effectively turning the crankshaft 112 by about 45°.

Once the third stage of the electromagnet 602 is complete and the status sensor 224 detects that the core 220 of the first electromagnet 602 reaches its original position, the controller 112 connects the first battery 206 to the second electromagnet 604. Accordingly, the battery 206 supplies a charge to the second electromagnet 604, thereby energizing it. Consequently, an electromagnetic field may be produced in the second electromagnet 604 that causes the core 220 to be pulled towards the shell 216, in turn turning the crankshaft 112 by about 45°. Subsequently, based on detection by the status sensor 224 that the core 220 has reached a predetermined top position, the controller 210 may disconnect the first battery 206 from the second electromagnet 604, and connect the second battery 208 to the electromagnet 604 instead. This, as described previously, causes the electromagnetic field to collapse, a corresponding charge to be stored in the second battery 208, and the core 220 to return to its original position, effectively turning the crankshaft 112 by about another 45°.

This process continues similarly with the third and fourth electromagnets 606, 608, until the crankshaft 112 is effectively rotated by about 360°. Thereafter, the process repeats continuously until brakes are applied. In the arrangement illustrated in FIG. 6, the controller 210 is configured to accurately control the timing of the connection and disconnection of the batteries 206, 208 to the each of the electromagnets 602, 604, 606, 608. For instance, to attain a certain speed with this arrangement, the controller 210 may be configured to switch the batteries in less than 3 microseconds. Accordingly, the controller 210, the switches 222 and the batteries 206. 208 may include high-speed circuitry such as high-speed MOSFETs. Moreover, to control the connection to the batteries so precisely, the status sensor 224 may monitor the position of the cores 220 with respect to the shells 216 or the angle of the connecting rods 610-616 with respect to the crankshaft 112 and provide these readings to the controller 210. Furthermore, in some embodiments, the controller 210 may be configured to monitor and control the rate of the current supplied to the electromagnets 602-608 and the pulsed current stored in the battery 208 in each cycle.

In addition to instantaneous charge, the controller 210 may be configured to monitor the total charge stored in the second battery 208 and compare this total stored charge with a threshold value to determine subsequent actions. For example, if the total stored charge is below a threshold value, the controller 210 may continue to connect the second battery 208 to the electromagnets to receive charge. However, if the stored charge exceeds a threshold value, the controller 210 may be configured to disconnect the second battery 208 from the electromagnets or continue to charge the second battery 208 at a slower rate. Following sections describe two scenarios where the controller 210 may select different outcomes when the total charge exceeds the threshold value.

In one case, the threshold value may be a value between about 60% to 80% of the battery charge. In this case, once the total charge exceeds the threshold value, the controller 210 may be configured to continue charging the battery 208 in small increments. To this end, the controller 210 may be configured to utilize charge from one electromagnet (e.g., electromagnet 602) or two alternative electromagnets (e.g., electromagnets 602 and 606) until the charge reaches a second threshold value (e.g., between 80% to 100% of the battery charge). Such incremental charge may prevent excessive heating.

Alternatively, the threshold value may be between about 80% to about 100%. In this case, the controller 210 may disconnect the battery 208 from the digital commutation system 114 as long as the total charge is above the threshold charge. Once the total charge drops below the threshold value, the battery 208 may be reconnected to the digital commutation system 114 for recharging.

In the arrangement illustrated in FIG. 6, it may also be noted that each electromagnet may include about 500 turns of the electromagnetic winding. Further, 500 turns may correspond to about 300 ft of wire. Also, to effectively charge the batteries, and drive the vehicle, the electromagnetic winding in each battery ma be capable of handling about 100 amperes of current at about 7 volts voltage.

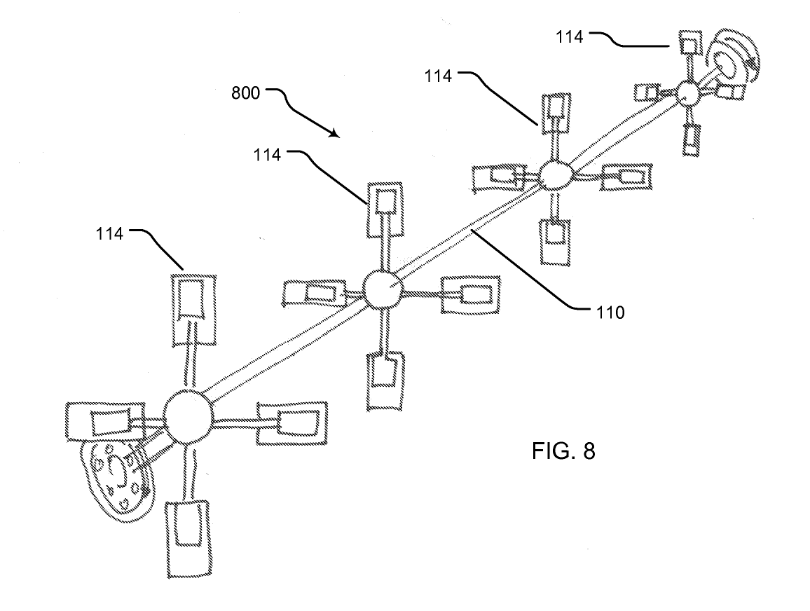

FIG. 8 illustrates an exemplary assembly 800 of the digital commutation system 114 of FIG. 6 on an electric vehicle, such as vehicle 100. As illustrated, one or more digital commutation system 114 may be coupled to any axle 110 of the vehicle 100. FIG. 8 illustrates four digital commutation system 114, each comprising four electromagnets. However, it may be understood that fewer or more digital commutation system 114 having fewer or more electromagnets may be coupled to the axle 110 without departing from the scope of the present disclosure.

The methods and systems discussed in the present disclosure provide a mechanism to recharge batteries of an electric vehicle from the charge required to move the vehicle. Accordingly, the batteries may be charged while the vehicle is in motion. Such recharging allows the vehicle to travel large distances without the need of stationary charging. Furthermore, the exemplary systems and methods of the present disclosure circumvent the excessive need for stationary charging stations.

Those in the art will understand that the steps set out in the discussion above may be combined or altered in specific adaptations of the disclosure. The illustrated steps are set out to explain the embodiment shown, and it should be anticipated that ongoing technological development will change the manner in which particular functions are performed. These depictions do not limit the scope of the present disclosure, which is determined solely by reference to the appended claims.

We claim:

1. A digital commutation system for charging one or more batteries of an electric vehicle, the digital commutation system comprising:
an electromagnet coupled to a crankshaft of the electric vehicle and configured to be operatively coupled to the one or more batteries to receive a current from the one or more batteries and supply charge to the one or more batteries;
an electromagnet status sensor configured to detect a status of the electromagnet; and
a controller configured to:
control coupling of the electromagnet to the one or more batteries based on the detected electromagnet status; and
monitor the current received by the electromagnet and the charge supplied from the electromagnet.

2. The digital commutation system of claim 1 further comprising one or more switches operatively coupled between the one or more batteries and the electromagnet.

3. The digital commutation system of claim 2, wherein the controller is configured to control operation of the one or more switches, based on the detected electromagnet status, such that at a given time one of the one or more batteries is coupled to the electromagnet.

4. The digital commutation system of claim 1, wherein the electromagnet comprises:
a cylindrical shell;
an electromagnetic winding disposed within the shell; and
a core slidably disposed within the electromagnetic winding.

5. The digital commutation system of claim 4, further comprising a connecting rod pivotally connected between the core and the crankshaft and configured to transfer a translation motion in the electromagnet into a rotational motion of the crankshaft.

6. The digital commutation system of claim 5, wherein the electromagnet status sensor comprises at least one of a core position detector or a connecting rod angle detector.

7. The digital commutation system of claim 5, comprising two electromagnets spaced 180° apart from each other around the crankshaft, the two electromagnets coupled to the crankshaft by two corresponding connecting rods, wherein each electromagnet cause the crankshaft to rotate by about 180°.

8. The digital commutation system of claim 5, comprising four electromagnets spaced about 90° apart from each other around the crankshaft, the four electromagnets coupled to the crankshaft by four corresponding connecting rods, wherein each electromagnet causes the crankshaft to rotate by about 90°.

9. The digital commutation system of claim 5, further comprising a spring assembly coupled between the shell and the core.

10. The digital commutation system of claim 5, wherein depending on the current supplied to the electromagnet, the core moves into the shell or out of the shell.

11. The digital commutation system of claim 1, wherein the charge supplied from the electromagnet is stored in the one or more batteries based on a pulse width modulation technique and a collapsing electromagnetic field in the electromagnet.

12. The digital commutation system of claim 1, wherein the controller is configured to compare the charge received from the electromagnet with a threshold value.

13. The digital commutation system of claim 10, wherein if the charge supplied from the electromagnet exceeds the threshold value, the controller is configured to:
stop supplying charge from the electromagnet to the one or more batteries; or
reduce the rate of receiving charge from the electromagnet until the received charge reaches a second threshold value.

14. A process for charging a battery of an electric vehicle, the process comprising:
supplying a current to an electromagnet comprising an electromagnetic winding and a core present within the winding, wherein the core is coupled to a crankshaft of the vehicle and wherein supply of the current is controlled by a controller;
producing an electromagnetic field, in the electromagnetic winding, based on the supplied current;
pulling the core into the winding based on the produced electromagnetic field;
collapsing the electromagnetic field by ceasing supply of the current to the electromagnet via the controller; and
storing a charge corresponding to the collapsed electromagnetic field.

15. The method of claim 14 further comprising:
monitoring a status of the electromagnet; and
supplying current to the electromagnet and storing a charge from the electromagnet based on the monitored status of the electromagnet.

16. The method of claim 14 further comprising returning the core to an original position when the electromagnetic field collapses.

17. The method of claim 14 further comprising monitoring the current supplied to the electromagnet and the charge stored from the electromagnet.

18. The method of claim 17 further comprising comparing the monitored current stored from the electromagnet with a threshold value.

19. The method of claim 18 further comprising at least one of:
reducing a rate of storing the charge from the electromagnet if the monitored charge is greater than the threshold value; or
discontinuing to store the charge from the electromagnet if the monitored charge is greater than the threshold value.

20. A vehicle operating under electric power, comprising:
a digital commutation system for charging one or more batteries of an electric vehicle, the digital commutation system including:
an electromagnet coupled to a crankshaft of the electric vehicle and configured to be operatively coupled to the one or more batteries to receive a current from the one or more batteries and supply charge to the one or more batteries;
an electromagnet status sensor configured to detect a status of the electromagnet; and
a controller configured to:
control coupling of the electromagnet to the one or more batteries based on the detected electromagnet status; and
monitor the current received by the electromagnet and the charge supplied from the electromagnet.
